(19) United States
(12) Patent Application Publication
(10) Pub. No.: US 2009/0248370 A1
(43) Pub. Date: Oct. 1, 2009

(54) Method and Apparatus for Applying "Quasi-Monte Carlo" Methods to Complex Electronic Devices Circuits and Systems

(75) Inventors: Rob Rutenbar, Pittsburgh, PA (US); Amith Singhee, Pittsburgh, PA (US)

Correspondence Address: Oppedahl Patent Law Firm LLC - SRC, P.O. Box 4850, Frisco, CO, 80443-4850, US

(73) Assignee: CARNEGIE MELLON UNIVERSITY, Pittsburgh, PA (US)

(21) Appl. No.: 12/057,260

(22) Filed: Mar. 27, 2008

(51) Int. Cl. G06F 17/50; G06F 17/11

(52) U.S. Cl. 703/2

(57) ABSTRACT

The invention discloses a “Quasi-Monte Carlo” method originally intended for computational finance applications and applies said method to statistical circuit analysis. In doing so, it provides a means to efficiently and effectively detect and/or predict relatively rare failures or events to a wide range of industrial circuits and systems. The approach to the invention involves the representation of circuit metrics as a large multi-dimensional integral. This invention estimates such statistical circuit metric integrals by sampling the statistical variable space using a so-called “low-discrepancy sequence.” This is similar to the Monte Carlo method, the main difference being the method of sampling the variable space. Compared with standard Monte Carlo simulation, this technique, “Quasi-Monte Carlo Methods,” gives similarly reliable estimates of the result, but requiring many fewer samples of the circuit or system being evaluated. In practice, speedups of 2× to 50× across a range of practical examples are observed.

### BACKGROUND

### Background Discussion

NOTE: Some of the references listed in the next subsection are referred to in this discussion using the reference number in square brackets, [ ].

Circuit reliability under statistical process variation is an area of growing concern. As transistor sizes are becoming smaller, small imperfections during manufacturing result in large percentage variation in the circuit performance. Hence, statistical analysis of circuits, given probability distributions of the circuit parameters, has become indispensable. Performing such analysis usually entails estimating some metric, like parametric yield, failure probability, etc. Designs that add excess safety margin, or rely on simplistic assumptions about “worst case” corners no longer suffice. Worse, for critical circuits such as SRAMs and flip flops, replicated across 10K-10M instances on a large design, there is the new problem that statistically rare events are magnified by the sheer number of these elements. In such scenarios, an exceedingly rare event for one circuit may induce a not-so-rare failure for the entire system. Existing techniques perform poorly when tasked to generate both efficient sampling and sound statistics for these rare events: Such techniques are literally seeking event in the 1-in-a-million regime, and beyond. Statistical metrics such as parametric yield and failure probability can be represented as high dimensional integrals and are often evaluated using a Monte Carlo simulation.

Monte Carlo analysis remains the gold standard for the required statistical modeling. Standard Monte Carlo techniques are, by construction, most efficient at sampling the statistically likely cases. However, when used for simulating statistically unlikely or rare events, these techniques are extremely slow. For example, to simulate a 5 event, 100 million circuit simulations would be required, on average.

There is another application domain characterized by many of the same technical challenges faced with semiconductors. That domain is computational finance. Indeed, the parallels are striking. There are celebrated analytical results, for example, the Nobel Prize winning Black-Scholes model for option pricing (see Background reference [2]). But there is also the reality that, as financial instruments have become ever more complex and subtle, analytical models have given way to Monte Carlo as the only practical analysis method (see Background reference [2]). The problems are not only very nonlinear, they can also be quite large: pricing a portfolio of options or securities over a several year horizon can create problems with 1000+ statistical variables (see Background reference [3]). Accuracy is often required to the level of one basis point (a relative accuracy of 10⁻⁴) under impressively short time constraints (minutes, in the case of real-time arbitrage).

The natural question becomes: Can any of these methods be redeployed, moving them from finance to flip flops? In particular, can recent Monte Carlo methods developed for quickly pricing complex financial instruments be retargeted to the problem of estimating statistical quantities of interest in deeply scaled circuits? To be concrete: Does the deep statistical structure of pricing a 30-year mortgage backed security resemble, in any practical and exploitable way, the structure of random dopant fluctuations in an SRAM column? As it turns out, the answer is “yes,” as is discussed later in the specification.

Consequently, there exists a need to develop Monte Carlo-type strategies that sample and interpret systems data (whether semiconductors or computational finance systems) much more rapidly and efficiently while maintaining meaningful results.

### LIST OF RELATED ART

The following is a listed of related art that is referred to in and/or forms some of the basis of other sections of this specification.
[1] M. Mani, A. Devgan, M. Orshansky, “An Efficient Algorithm for Statistical Minimization of Total Power under Timing Yield Constraints”, IEEE/ACM DAC, 2005.
[2] P. Glasserman, “Monte Carlo Methods in Financial Engineering”, Springer, 2004.
[3] S. Ninomiya, S. Tezuka, “Toward Real-time Pricing of Complex Financial Derivatives”, App. Math. Fin., 3(1), pp. 1-20, 1996.
[4] J. H. Halton, “On the Efficiency of Certain Quasi-Random Sequences of Points in Evaluating Multi-dimensional Integrals”, Nuremische Mathematik, 2, pp. 84-90, 1960.
[5] A. Papageorgiou, J. F. Traub, “Beating Monte Carlo”, Risk, 1996.
[6] H. Niederreiter, “Random Number Generation and Quasi-Monte Carlo Methods”, SIAM, 1992.
[7] E. Hlawka, “Funktionen von beschränkter Variation in der Theorie der Gleichverteilung”, Annali di Matematica Pura ed Applicata, 54, pp 325-333, 1961.
[8] R. E. Caflisch, W. Morokoff, A. Owen, “Valuation of Mortgage Backed Securities Using Brownian Bridges to Reduce Effective Dimension, J. Comp. Fin., 1, pp. 27-46, 1997.
[9] K.-L. Chung, “An Estimate Concerning the Kolmogoroff Limit Distribution”, Trans. Amer. Math. Soc., Vol 67, pp. 36-50, 1949.
[10] I. M. Sobol', “The Distribution of Points in a Cube and the Approximate Evaluation of Integrals”, USSR Comp. Math and Math. Phys., 7(4), pp. 86-112, 1967.
[11] H. Faure, “Discrépance de Suites Associées à un Système de Numération (en Dimensions)”, Acta Arith., 41, pp. 337-351, 1982.
[12] H. Niederreiter, “Low-Discrepancy and Low-Dispersion Sequences”, J. Number Theory, 30, pp. 51-70, 1988.
[13] H. Niederreiter, C. Xing, “The Algebraic Geometric Approach to Low-Discrepancy Sequences”, Monte Carlo and Quasi-Monte Carlo Methods, pp. 139-160, 1996.
[14] P. Acworth, M. Broadie, P. Glasserman, “A Comparison of some Monte Carlo and Quasi-Monte Carlo Techniques for Option Pricing”, Monte Carlo and Quasi-Monte Carlo Methods, pp. 1-18, 1996.
[15] P. Bratley, B. L. Fox, “Algorithm 659: Implementing Sobol's Quasirandom Sequence Generator”, ACM Trans. Math. Soft., 14(1), pp. 88-100, 1988.
[16] S. Joe, F. Y. Kuo, “Remark on Algorithm 659: Implementing Sobol's Quasirandom Sequence Generator”, ACM Trans. Math. Soft., 29(1), pp. 49-57, 2003.
[17] W. W. Peterson, E. J. Weldon, “Error-Correcting Codes”, 2nd ed., MIT Press, 1972.
[18] F. J. Hickernell, “A Generalized Discrepancy and Quadrature Error Bound”, Math. of Comput., 67, pp. 299-322, 1998.
[19] X. Wang, K.-T. Fang, “The Effective Dimension and Quasi-Monte Carlo Integration”, J. Complexity, 19, pp. 101-124, 2003.
[20] G. E. Noether, “Introduction to Statistics: The Nonparametric Way”, Springer, 1990.
[21] A. B. Owen, “Randomly permuted (t, m, s)-nets and (t,s)-sequences”, Monte Carlo and Quasi-Monte Carlo Methods, pp. 299-317, 1995.
[22] A. B. Owen, “Variance with Alternative Scramblings”, ACM Trans. Model. and Comp. Sim., 13(4), pp. 363-378, 2003.
[23] H. S. Hong, F. J. Hickernell, “Algorithm 823: Implementing Scrambled Digital Sequences”, ACM Trans. Math. Soft., 29(2), pp. 95-109, 2003.
[24] G. Ökten, W. Eastman, “Randomized Quasi-Monte Carlo Methods in Pricing Securities”, J. Eco. Dyn. and Contr., 28(12), pp. 2399-2426, 2004.
[25] M. Matsumoto, Y. Kurita, “Twisted GFSR Generators II”, ACM Trans. Model. and Comp. Sim., 4, pp. 254-266, 1994.
[26] S. Tezuka, “Uniform Random Numbers: Theory and Practice”, Kluwer, 1995.
[27] W. Zhao, Y. Cao, ‘New Generation of Predictive Technology Model for sub-45 Design Exploration”, ISQED, 2006.
[28] H. Banba et al., “A CMOS Bandgap Reference Circuit with Sub-1-V Operation”, IEEE J. Solid State Cir., 34(5), pp. 670-674, 1999.
[29] D. Johns, K. Martin, “Analog Integrated Circuit Design”, Wiley, 1996.
[30] R. V. Hogg, A. T. Craig, “Introduction to Mathematical Statistics”, 3^{rd} ed., MacMillan, 1971.

### BRIEF SUMMARY OF THE INVENTION

The invention provides a means to efficiently and effectively detect and/or predict relatively rare failures or events to a wide range of industrial circuits and systems. The approach to the invention involves the representation of circuit metrics as a large multi-dimensional integral. This invention estimates such statistical circuit metric integrals by sampling the statistical variable space using a so-called “low-discrepancy sequence.” This is similar to the Monte Carlo method, the main difference being the method of sampling the variable space.

Compared with standard Monte Carlo simulation, this technique, “Quasi-Monte Carlo Methods,” gives similarly reliable estimates of the result, but requiring many fewer samples of the circuit or system being evaluated. In practice, speedups of 2× to 50× across a range of practical examples are observed.

### BRIEF DESCRIPTION OF THE DRAWINGS

FIG. 1 depicts pseudo-random points exhibiting higher discrepancy than a low-discrepancy quasi-random sequence.

FIG. 2 depicts undesirable patterns in 2-D projections of low-discrepancy sequences.

FIG. 3 depicts a master-slave flip-flop with scan chain component.

FIG. 4 depicts MSFF parameters sorted by decreasing importance, estimated by the absolute value of rank correlation.

FIG. 5 depicts a 64-bit SRAM column with mux and write drivers.

FIG. 6 depicts a 0.6-V-output CMOS bandgap.

FIG. 7 depicts a comparison of estimates from Monte Carlo (Pseudo-random) and Quasi-Monte Carlo (Scrambled Sobol').

FIG. 8 depicts a QMC estimate with increasing number of points, for the correct variable-dimension mapping (variables sorted with decreasing rank correlation), and for the reversed mapping (increasing rank correlation).

FIG. 9 depicts a comparison of standard deviation of estimates from Monte Carlo (Pseudo-random) and Quasi-Monte Carlo (Scrambled Sobol').

### DETAILED DESCRIPTION

NOTE: Some of the references listed in the Background section are referred to in this description using the reference number in square brackets, [ ].

### First Embodiment

### Low-Discrepancy-Sequence-Based Quasi-Monte Carlo Applied to Circuit Design

This embodiment involves the application of one of the most celebrated methods developed in computational finance in the last decade: the Quasi Monte Carlo (QMC) method to statistical circuit analysis, using a computing device programmed to use QMC as it evaluates circuit metric data. As with all Monte Carlo methods, the goal is to converge to the required accuracy as rapidly as possible, with as few sample simulations as possible. Although the underpinnings of QMC are not new (see Background reference [4]), recent improvements in both theory and implementation complexity, along with the empirical discovery that these methods are unexpectedly efficient at high-dimensional statistical integral evaluation, propelled these techniques onto center stage in the computational finance world (see Background reference [5]).

Unfortunately, like all complex mathematical methods, correct application requires adapting the strengths of the methods to the specifics of the problem. In other words, these ideas cannot be applied blindly and expect to extract maximum (or, perhaps, any) benefit. This embodiment reviews the convergence theory for both standard Monte Carlo and QMC methods, and show how to correctly apply these ideas to a range of statistical circuit analysis problems.

### Standard Monte Carlo Convergence Behavior

Monte Carlo methods are typically used to approximate some integral of the following standard form:

I(f)=∫_{C}_{^{s}}ƒ(x)dx,x=(x₁, . . . , xₛ) (Equation 1)

Where C^{s}=[0, 1)^{s} is the s-dimensional unit cube, and ƒ is some integrable function.

The Monte Carlo approximation is given by

$$Q ( f ) = {n}^{- 1} {\sum }_{i = 1}^{n} f ( {x}_{i} ) , \qquad ( Equation 2 )$$

where xᵢ are n independent and identically distributed samples drawn from the s-dimensional uniform distribution U[0, 1)^{s}.

Problems with different variable ranges, arbitrary statistical distributions, arbitrary nonlinearity, etc., can always be transformed into this canonical integral form; i.e., these can always be included in our function ƒ, without any loss of generality. Thus, the problems we discuss are all defined over the s-dimensional unit cube. Parametric yield computation for circuits also follows the form in Equation 1. Given this, let us look at the convergence properties of standard Monte Carlo.

If has finite variance

σ²(ƒ)=∫_{C}_{^{s}}[ƒ(x)−I(ƒ)]²dx (Equation 3)

then the mean square error of the Monte Carlo integral approximation is given as

E[(Q(ƒ)−I(ƒ))²]=σ²(ƒ)/n (Equation 4)

Hence, the expected Monte Carlo error is O(n^{-1/2}). The advantage of standard Monte Carlo is that this error does not depend on the dimensionality s.

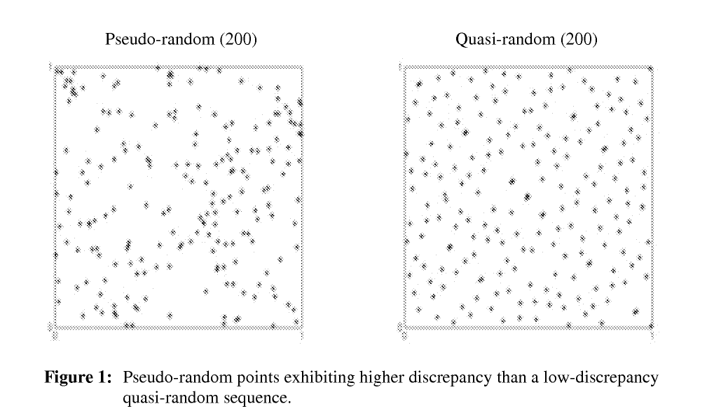

There is another way to look at the error, using the concept of discrepancy. FIG. 1 shows 200 uniformly distributed pseudo-random points in C². The points are, indeed, uniformly distributed, but geometrically, they are not equally separated. We can see that the points exhibit both clumps and empty holes. Discrepancy is a quantity used to reflect this geometric non-uniformity of points in a set.

There are several definitions of discrepancy (see Background reference [6]), the simplest being the Star Discrepancy, or the L_{∞}-discrepancy:

D*ₙ=supJ|A(J;n)/n−Vol(J)|, (Equation 5)
where JεC^{s} is any s-dimensional hyper-rectangle with one corner at 0. Vol(J) is the volume of J, and A(J;n) is the number of points inside J.

Geometrically speaking, the star discrepancy measures how well the (relative) volume of any origin-anchored hyper-rectangle in the unit cube is approximated by the fraction of sample points that lie in that volume. Surprisingly enough, samples from the standard uniform distribution xᵢ˜U[0, 1)^{s} may show extremely large discrepancy, as FIG. 27 so clearly illustrates.

The Koksma-Hlawka theorem (see Background reference [7]) quantifies this effect. If has a suitably bounded variation V(ƒ) then the absolute integration error is itself bounded by the star discrepancy, as:

|Q(ƒ)−I(f)|≦V(ƒ)D*ₙ (Equation 6)

(V(ƒ) itself has a rather technical definition; see Background reference [8].) The larger implication is that sample points with lower discrepancy can produce integral estimates with lower errors.

The first obvious question is: What is the discrepancy for standard Monte Carlo? Chung (see Background reference [9]) showed that, for uniform points xᵢ˜U[0, 1)^{s},

$${D}_{n}^{*} = O ( {( \frac{log log n}{n} )}^{1 / 2} ) \qquad ( Equation 7 )$$

Thus, there is an echo of the familiar convergence behavior. But the real question is this: Are there sampling sequences that guarantee a better, lower discrepancy? The answer is “yes”.

### Quasi-Monte Carlo

Sequences with asymptotically superior discrepancy exist and are known as Low Discrepancy Sequences (LDSs). FIG. 1 also shows 200 points drawn from such a sequence (points from a so-called Sobol' sequence (see Background reference [10])). The higher uniformity, as compared to pseudo-random points, is obvious. Theoretically, the discrepancy bound for these points is

D*ₙ=O((log n)^{s}/n) (Equation 8)

and they possess the surprising attribute that they are generated deterministically, in contrast to the standard pseudo-random sampling of classical Monte Carlo. Monte Carlo performed using samples generated deterministically from a low discrepancy sequence is known as Quasi-Monte Carlo (QMC). LDSs are also known as Quasi-Random Sequences. The overall idea is conceptually simple: Rather than randomly sampling the space, the space is attempted to be filled with samples that are as geometrically, homogeneously equidistant as possible.

Comparing the bounds of Equations 7 and 8 gives some sense of the possible advantages, and challenges, of the method. Comparing denominators, there is the tantalizing possibility of linear convergence for QMC. But comparing numerators, the advantages of QMC may, for larger problems (large dimensionality s), only make themselves apparent after a huge number of sample points n. Luckily, in many empirical situations, this turns out not to be the case; this is discussed later in this embodiment.

The first construction of an LDS for all problem dimensions was given by Halton in 1960 (see Background reference [4]). Other constructions have been introduced by Sobol' (see Background reference [10]), Faure (see Background reference [11]), Niederreiter (see Background reference [12]) and Niederreiter and Xing (NX) (see Background reference [13]). Space does not permit any detailed survey of the different strategies here; see Background reference [2] for a survey. Niederreiter showed a general construction principle for one large and popular class of LDSs called (t,s)-sequences (see Background reference [6]). One particularly successful set of (t,s)-sequence, called Sobol' point, was used for the experiments.

### Sobol Points

Sobol's construction, introduced in Background reference [10], is one of the most popular in current use. Sobol' points perform significantly better than the original Halton points in terms of discrepancy. Also, empirical results (see Background references [2] and [14]) suggest that Sobol' points perform better than Faure points—at least, for modern computational finance applications. The NX points promise to have significantly better discrepancy (see Background reference [13]). However, their implementation is significantly more complex and, currently, not flexible enough for an arbitrary problem dimension s, requiring the solution of a set of thorny number theoretic problems for each dimension. For all these reasons, the Sobol' points were chosen as the representative LDS.

The following is offered to briefly describe the Sobol' points construction. Implementations in Background references [15] and [16] are used. First, suppose that only one dimension is being worked in; i.e., s=1. One primitive polynomial (see Background reference [17]) is chosen in the field Z₂ (coefficients from {10,1})

P≡x^{d}+a1x^{d-1}+ . . . +ad−1x+1 (Equation 9)

Also, odd integers are chosen, m₁, . . . , m_{d}, such that 0<mⱼ<2^{j}. Define direction numbers

vⱼ=mⱼ/2^{j},j≦d (Equation 10)

and their recurrence relation (in Boolean operations)

vⱼ=a₁vⱼ₋₁⊕ . . . ⊕a_{d-1}v_{j-d+1}⊕v_{j-d}⊕(v_{j-d}/2^{d}),j>d (Equation 11)

This results in a set of direction numbers vⱼ for j>0. To compute the n-th Sobol' value xₙ, the following equation is used:

xₙ=n₁v₁⊕n₂v₂⊕ . . . , (Equation 12)

where . . . n₃n₂n₁ is the Gray code representation of n.

Using the Gray code representation is must faster than using the binary representation, since only one bit changes in the Gray code from n to n+1, making the operation in Equation 12 incremental (only one XOR). This reshuffling does not affect the asymptotic discrepancy.

For a general problem with s>1 dimensions, s different primitive polynomials are chosen and sequences for each coordinate are generated, using the above method. The polynomials are chosen sequentially with non-decreasing degree d, for increasing dimension.

One additional problem is how to choose the initial values for each dimension i. Each of these shall be named as mⱼ. Also, renaming the direction numbers as v_{i,j}, where i is the dimension 1≦i≦s, v_{i,j,1} is defined as the first bit after the binary point of v_{i,j}. Set

V_{d}=[v_{i,j,1}],where 1≦i≦d and 1≦j≦d (Equation 13)

Then, according to Sobol's development in Background reference [10], the condition

det(V_{d})=1(mod 2) (Equation 14)

gives better uniformity. Hence, m_{i,j} are chosen to satisfy Equation 14 (see Background reference [16]).

A generator for Sobol' points is relatively straightforward to implement, requiring mainly bit-level Boolean operations, and relatively little of the number-theoretic difficulty of some of the other LDS strategies. However, all LDS schemes suffer from some idiosyncrasies when applied to higher dimensional problems, requiring additional finesse in the way statistical integration problems are mapped into a viable QMC formulation.

### Minimizing QMC Integration Error: Effective Dimension & LDS Pattern Effects

Looking only at the asymptotics, the O((log n)^{s}/n) error bound of QMC should show no runtime improvements over O(n^{-0.5}) the bound of conventional Monte Carlo for very large s and feasibly large n. However, QMC has been seen to outperform Monte Carlo even for problems with very large s; e.g., IBM's1439-dimensional derivative-pricing experiments of Background reference [3]. This anomalous, empirical success has been largely explained using the concept of effective dimension (see Background reference [8]). The concept is reviewed here because it strongly impacts the manner in which will map the circuits problems into a successful QMC form.

Reviewing first the concept of the Analysis of Variance (ANOVA) Decomposition, the decomposition expresses a function ƒ(x) as a sum of simpler functions ƒᵤ(x), each depending on a subset of the inputs x=(x₁, . . . , xₛ). For any subset u⊂{1, . . . , s} let −u be its complementary set {1, . . . s}−u and let xᵤ={xᵢ}, iεu be the sub-vector of coordinates of corresponding to U. Also, let C^{u} denote the unit cube in the dimensions that belong to u. Then, for any square integrable function ƒ, the ANOVA decomposition is

$$f ( x ) = {\sum }_{u ⊆ \{ 1 , … , s \}} {f}_{u} ( x ) , \qquad ( Equation 15 )$$

where the ANOVA terms follow the recursion

$$f ( x ) = {\int }_{{C}^{- u}} f ( x ) d {x}_{- u} - {\sum }_{v ⋐ u} {f}_{v} ( x ) \qquad ( Equation 16 )$$

and are orthogonal. Hence, the variance off can be written as

$${σ}^{2} ( f ) = {\sum }_{\vert u \vert > 0} {σ}_{u}^{2} ( f ) , \\ where \\ {σ}_{u}^{2} ( f ) = {\int }_{{C}^{s}} {( {f}_{u} ( x ) )}^{2} d x \qquad ( Equation 17 )$$

Definition 1. The effective dimension of ƒ, in the superposition sense, is the smallest integer

$${s}_{S} , s . t . {\sum }_{0 < \vert u \vert \leq ss} {σ}_{u}^{2} ( f ) \geq p {σ}^{2} ( f ) .$$

Definition 2. The effective dimension of ƒ, in the truncation sense, is the smallest integer

$${s}_{S} , s . t . {\sum }_{u ⊆ \{ 1 , … ST \}} {σ}_{u}^{2} ( f ) \geq p {σ}^{2} ( f ) .$$

Hence, s_{T} is the number of leading dimensions, in a fixed ordering, that account for most of the variance in the function, while s_{S} is an indicator of whether only low-dimensional interactions dominate the variation in ƒ. For example, ƒ(x)=x₁+x₂+x₃ has truncation dimension 4, but superposition dimension 1.

Effective dimension is relevant for two important reasons. First, it is widely invoked to help explain why QMC has been so strikingly efficient (e.g., 150× speedup (see Background reference [3])) on large financial problems. These tasks seem to have low effective dimension; for example, in a pricing task with a long time horizon. Money today is much more valuable than money tomorrow, which reduces the impact of many dimensions of the problem. It is an open question if this behavior obtains in circuit analysis. Second, effective dimension is essential to optimally map problems into QMC form, which we discuss next.

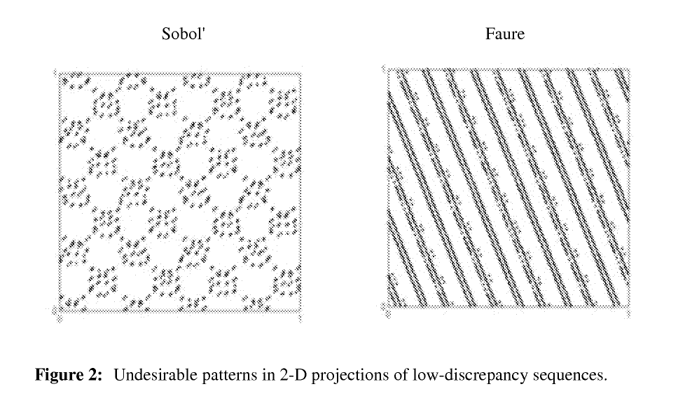

Ideally, it should not matter how problem variables are assigned to elements in our LDS points x=(x₁, . . . , xₛ). Suppose, for example, there are 100 random threshold voltages to sample. It should not matter if any particular voltage is mapped to x₁, or x₃₇, or x₉₉. Unfortunately, this is not the case. All LDSs are imperfect, and usually show degraded uniformity as dimension increases. This takes the form of pattern dependencies (see Background reference [8]), illustrated in FIG. 2. Taking two arbitrary elements (x₁, xⱼ) from point x=(x₁, . . . , xₛ), there should be a low-discrepancy 2-D projection such as FIG. 1. This is not always the case, as shown for two LDSs in FIG. 2.

This problem can be finessed by trying to assign the most “important” statistical variables to the lower, less pattern sensitive coordinates of x. More formally, in the language of ANOVA, we can write

$$\vert Q ( f ) - I ( f ) \vert \leq {\sum }_{u ⊆ \{ 1 , … , s \}} {V}_{u} ( {f}_{u} ) {D}_{n , u}^{*} , \qquad ( Equation 18 )$$

Where Vᵤ(θᵤ) is the variation of ƒᵤ taken as a |u|-dimensional function (see Background reference [18]), and D*_{n,u} is the star-discrepancy of the |u|-dimensional points obtained by projecting the sequence onto the coordinates in u.

This suggests that if ƒ has low s_{S}, then, because of lower D*_{n,u}, QMC will perform better than Monte Carlo. But to deal with the pattern effects of FIG. 2, the input values {xᵢ} should be mapped to the coordinates of the LDS such that subsets u with large σᵤ(Vᵤ(ƒᵤ)) and small D*_{n,u} coincide, and those with large D*_{n,u} and small σᵤ coincide. If this can be done, then very low error can still be achieved.

For problems with a time-series random-walk structure, there are good techniques for mapping (see Background reference [19]), but these are not applicable in the case of circuit yield analysis. Principal Components analysis (PCA) is obviously useful, but even here, we still need to be able to best map the problem to a QMC form after PCA has completed. Two strategies are suggested:
1. The designer selects the parameters that most affect the relevant performance metrics, and assigns these to the lower coordinates of the QMC.
2. The global sensitivity of the metric to circuit parameters is used a measure of their “importance”, and the parameters are sorted in decreasing order of importance. This sorted list is then mapped to the corresponding LDS coordinates.

The latter method is concentrated on here. The measure of sensitivity that we use is the absolute value of the Spearman's Rank Correlation Coefficient (see Background reference [20]). This is similar to Pearson's Correlation, but more robust in the presence of non-linear relationships. Suppose Rᵢ and Sᵢ are the ranks of corresponding values of a parameter and a metric, then their rank correlation is given as:

$${r}_{s} = \frac{{\sum }_{i} ( {R}_{i} - \overline{R} ) ( {S}_{i} - \overline{S} )}{\sqrt{{\sum }_{i} {( {R}_{i} - \overline{R} )}^{2}} \sqrt{{\sum }_{i} {( {S}_{i} - \overline{S} )}^{2}}} \qquad ( Equation 19 )$$

This approach has a two-fold advantage. First, it helps reduce the truncation dimension, since all the important dimensions are the first few. Second, the first few dimensions of the Sobol' points are more uniform for small (see Background references [2] and [19]), and this approach helps map the important subset of variables (large σᵤ) to the dimensions with good uniformity (small D*_{n,u}). The rank correlation can be computed by first running a smaller Monte Carlo run. For multiple metrics, the sum of the rank correlation values across all the metrics is used.

### Randomized QMC

One final problem is now confronted: The error bound Equation 6 for QMC is very difficult to compute. Also, it is only an upper bound on the error: It does not provide a practical way to measure the actual error, if the exact solution is unknown. In a standard Monte Carlo scenario, several different pseudo-random samplings would be simply run and compared. But QMC generates deterministic samples: Each run yields the same samples. To address this, Owen (see Background reference [21]) introduced Randomized QMC (RQMC) to estimate the variance, using so-called scrambled versions of the same LDS. Let {x₀, x₁, . . . } and {y₀, y₁, . . . } denote the original LDS and a randomly scrambled version, respectively. Let xₙᵢ=0, xₙᵢ₁xₙᵢ₂ . . . be the i-th coordinate of xₙ. Then,

yₙᵢ₁=πⁱ(nᵢ₁), and yₙᵢₖ=πₓ_{ₙᵢ₁}_{, . . . , x}_{_{nik−1}}ⁱ(xₙᵢₖ) for k>1 (Equation 20)

where π_{( . . . )} are random permutations of {0, 1, . . . , b−1}, chosen uniformly and mutually independently.

Hence, this method scrambles the digits of the original LDS. Other methods have also been introduced (see Background reference [22]). All these randomized sequences maintain the uniformity properties of the original LDS.

Owen's original scrambling uses a large amount of memory. Hence, a more scalable, but less powerful, version is used, described in Background reference [23].

### Experimental Results for Circuit Analysis

In this discussion, the performance of the scrambled Sobol' points is compared against the performance of standard Monte Carlo, on three different testcases. First, some observations can be made about the Monte Carlo and RQMC implementations:
Since LDSs perform better when the first few points are skipped, the first nₛₖᵢₚ=2^{[log} ^{₂}^{n]} Sobol' points are skipped (see Background reference [14]).
A Linear Congruential Generator (LCG) (see Background reference [2]) (drand48( ) in C) was used to generate the pseudo-random sequences for standard Monte Carlo because of its widespread popularity. Variance results in (see Background reference [24]), comparing LCG with a Generalized Feedback Shift Register Generator (GFSR) (see Background reference [25]), do not show significant improvement for GFSR, relative to the improvement with RQMC.
The standard Box Muller method for generating normally distributed variates is inaccurate, especially for a large number of samples (see Background reference [26]). Hence, an inverse transform method was used.

Now, the testcases and the experiments will be discussed. All samples were evaluated using detailed circuit simulation in Cadence Spectre. Results for all testcases will be analyzed together later in this embodiment.

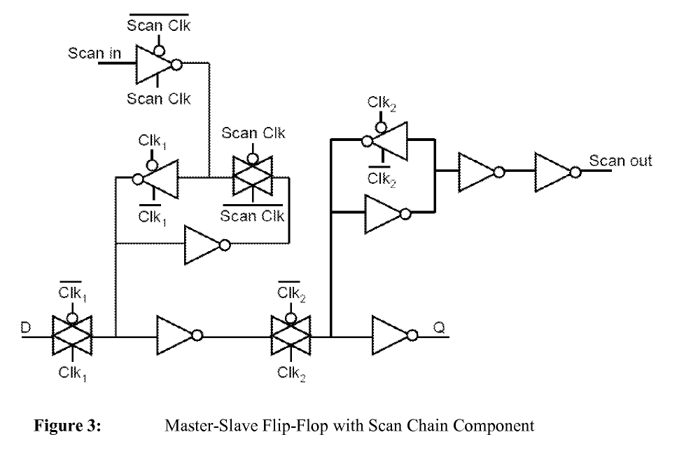

The first testcase is a commonly seen Master-Slave Flip-Flop with scan chain (MSFF), FIG. 3. The design has been implemented using the 45 nm CMOS Predictive Technology Models of Background reference [1]. Variations considered are Random Dopant Fluctuation (RDF) for all transistors and one global gate-oxide (tₒₓ) variation. The RDF is modeled as normally distributed threshold voltage (Vₜ) variation:

σ(Vₜ)=0.0135Vₜ₀/\sqrt{WL} where W,L are in μm (Equation 21)

Vₜ₀ is the nominal threshold voltage. This results in 30% standard deviation for a minimum-sized transistor. The tₒₓ standard deviation is taken as 2%. The metric being measured is the clock-output delay, τ_{cq}. The integral being estimated is the parametric yield, with a maximum acceptable delay of τₘₐₓ=200 ps. If we define

$${I}_{t} ( z , f ( z ) ) = \{ \begin{matrix}1 , & f ( z ) \leq t \\ 0 , & f ( z ) > t\end{matrix} \qquad ( Equation 22 )$$

then yield can be expressed in the form (Equation 1) as follows:

Yₜ(ƒ,φ)=ƒ_{C}_{^{s}}Iₜ(φ(x),ƒ(φ(x)))dx (Equation 23)
where Φ(x) transforms uniformly distributed xε[0, 1)^{s} to the required joint distribution (normal in this case).

There are a total of 31 statistical variables in this problem. For the MSFF, yield will be given as γ_{τ}_{ₘₐₓ}(τ_{cq}, Φ). Ten Monte Carlo runs of 50,000 pseudo-random points each were run. One QMC run with 50,000 Sobol' points, and 9 QMC runs with 50,000 scrambled Sobol' points each were also run. Results are discussed later in this embodiment.

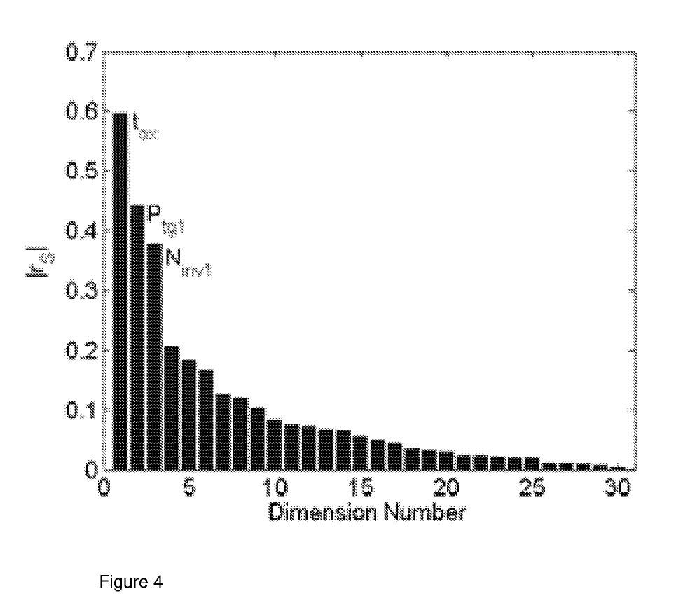

As an illustrating example, consider how the rank correlation-based variable-dimension mapping works for this testcase. FIG. 4 shows the absolute value of the rank correlation (|rₛ|) of each circuit parameter with the clock-output delay, for rising output, computed from an initial Monte Carlo run of 1000 samples. The variable are sorted according to decreasing importance (|rₛ|): In the order they would be mapped to the dimensions of the Sobol' sequence. The three most important parameters are labeled: 1) tₒₓ: global gate oxide variation, 2) P_{tg1}:Vₜ the variation of the pMOS device in the input transmission gate Tg1, and 3): the variation of the nMOS device in the inverter Inv₁. The latter two devices are on the critical signal path for a high input causing a rising output, and are important for correctly sampling a “1” at the input, especially when the input timing is close to the setup limit. Since, the input was timed in such a manner in the testbench, these measures of importance make intuitive sense.

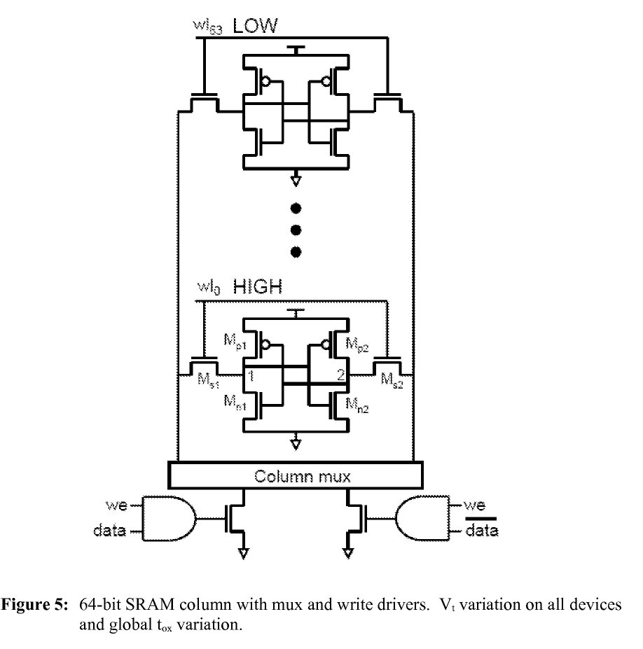

The second testcase is a 64-bit SRAM column. Yield analysis of SRAMs is unavoidable, given the large capacity of SRAMs and large variation due to RDF. Our second testcase is a 64-bit SRAM Column, with non-restoring write driver and column multiplexor (FIG. 5). Only one cell is being accessed, while all the other wordlines are turned off. The device models used are from the Cadence 90 nm Generic PDK library. RDF on all 402 devices (including the write driver and column mux) are considered, along with one global gate-oxide variation. All variations are assumed to be normally distributed. The Vt standard deviation is taken as

σ(Vₜ)=5mV/\sqrt{WL} where W,L are in μm (Equation 24)

This variation is too large for the 90 nm process, but is in the expected range for more scaled technologies. σ(tₒₓ) is taken to be 2%.

The metric being measured is the write time τ_{w}: the time between the wordline going high to the non-driven cell node (node 2) transitioning. Here, “going high” and “transitioning” imply crossing 50% of the full voltage change. The write time is measured as a multiple of the fanout-4 delay of an inverter (FO4). The value being estimated is the 90-th percentile of the write time. If we write

$${J}_{p} ( z , {Y}_{p} f , φ ) = \{ \begin{matrix}0 , & {Y}_{f ( φ ( z ) )} ( f , φ ) \neq p / 100 \\ 1 , & {Y}_{f ( φ ( z ) )} ( f , φ ) = p / 100\end{matrix} \qquad ( Equation 25 )$$

then any p-th percentile can be expressed in form (Equation 1) as

πₚ(f,φ)=∫_{C}_{^{s}}Jₚ(x,Yt,f,φ)dx (Equation 26)

then, the 90-th percentile in this case will be π₉₀₀(τ_{w}, Φ).

Ten Monte Carlo runs of 20,000 pseudo-random points each were run. One QMC run of 20,000 Sobol' points and 9 QMC runs of 20,000 scrambled Sobol' points each, were also run. The results are discussed later in this embodiment.

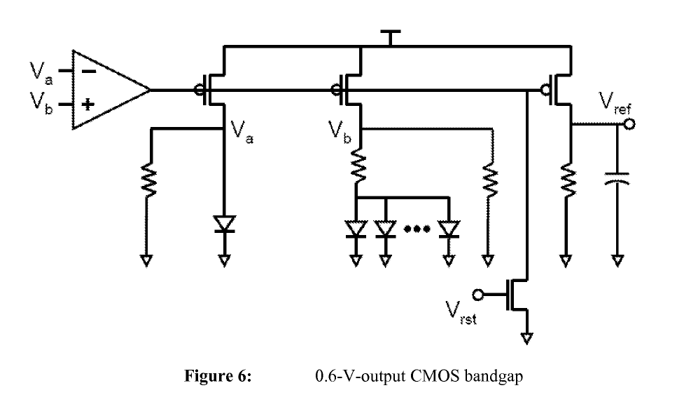

The third testcase is a low-voltage CMOS bandgap reference. FIG. 6 shows a low-voltage CMOS Bandgap Reference circuit (see Background reference [28]). This bandgap is able to provide reference voltages that are less than 1 Volt, and is built using standard CMOS technology. This circuit was chosen for its relevance in today's low-voltage designs, and also to test QMC on a circuit with highly non-linear behavior. The opamp used is a standard single-ended RC-compensated two-stage opamp (see Background reference [29]). The circuit has 101 diodes. The transistor device and variation models are the same 90 nm CMOS as the SRAM. RDF in the diodes is modeled as normally distributed variations on the saturation current, with standard deviation of 10%. Each resistor and capacitor has its own normally distributed variation source, with a standard deviation of 5%. There are a total of 121 local variation parameters and one global tₒₓ variation.

In this case, three metrics are measured: 1) output voltage (V_{ref}), 2) settling time (τ_{S}) and 3) dropout voltage (V_{do}). V_{do} is the difference between the supply voltage and V_{ref} when V_{ref} falls by 1% of its nominal value (0.6V): lower V_{do} implies a more robust circuit. The circuit performance is deemed acceptable only if V_{ref} is within 10% of 0.6V, τₛ≦200 ns, and V_{do}≦0.9V. The yield integral can be written in form (Equation 1), similar to as was done for the MSFF discussed earlier. Ten Monte Carlo runs of 10,000 pseudo-random points each were run. One QMC run of 10,000 Sobol' points and nine QMC runs of 10,000 scrambled Sobol' points each, were also run.

### Analysis of Results

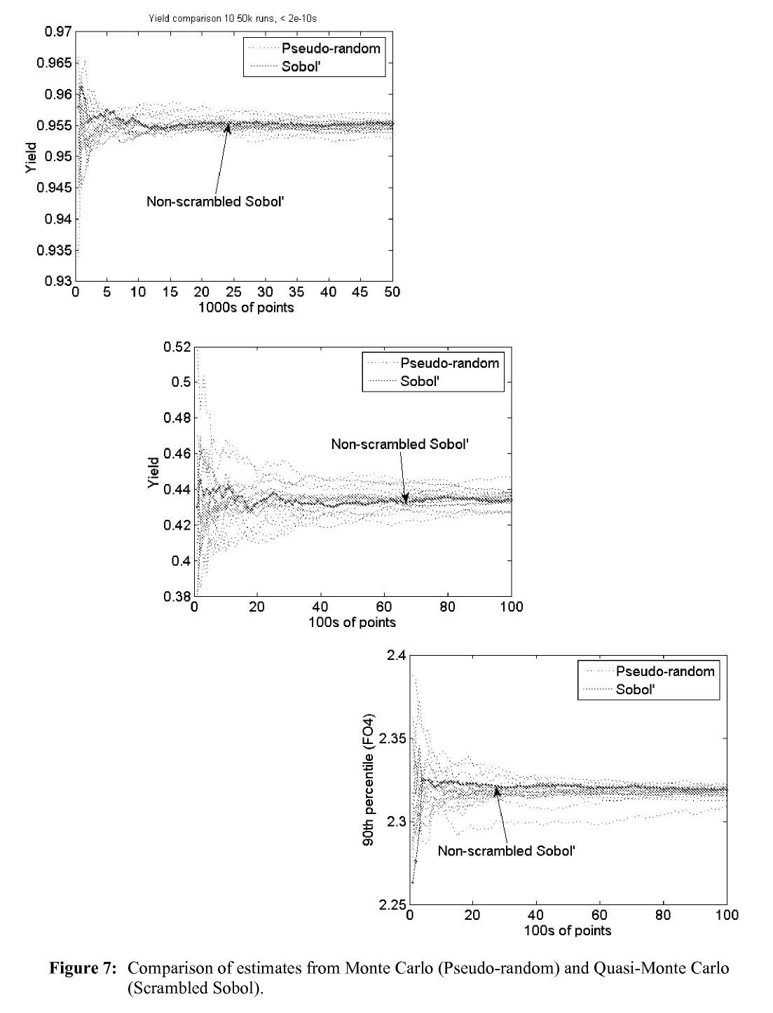

FIGS. 21 and 23 present the results for all three testcases. FIG. 7 plots the values of the estimates with increasing number of points for each Monte Carlo (pseudo-random) and QMC (Sobol') run. For all three cases, it can be clearly seen that the QMC graphs converge more quickly than the Monte Carlo graphs. In particular, the non-scrambled Sobol' points converge very fast towards the final result. This fact provides indirect validation that the rank correlation-based dimension mapping is an effective heuristic. Scrambling the digits of an LDS changes the way the space is filled up, and hence, changes the patterns and the discrepancies of the projections of the sequence. What is observed is that changing the patterns in this way causes the QMC performance to degrade in general. This implies that the rank correlation arranges the variables in a way that is optimal (or close to optimal), given the patterns of the non-scrambled LDS. This behavior is more pronounced as the problem dimensionality increases from MSFF to the SRAM Column, suggesting that for low dimensionality (e.g. 31-D MSFF), the LDS is uniformly distributed even for few samples; that is, has few patterns. For high dimensional problems, however, effective variable-dimension mapping should give notable improvement, over a random or uneducated assignment of variables to LDS dimensions. The best estimates shown are computed using all the points from all the Monte Carlo and QMC runs. These estimates will be used as the “exact” values of the quantities being measured.

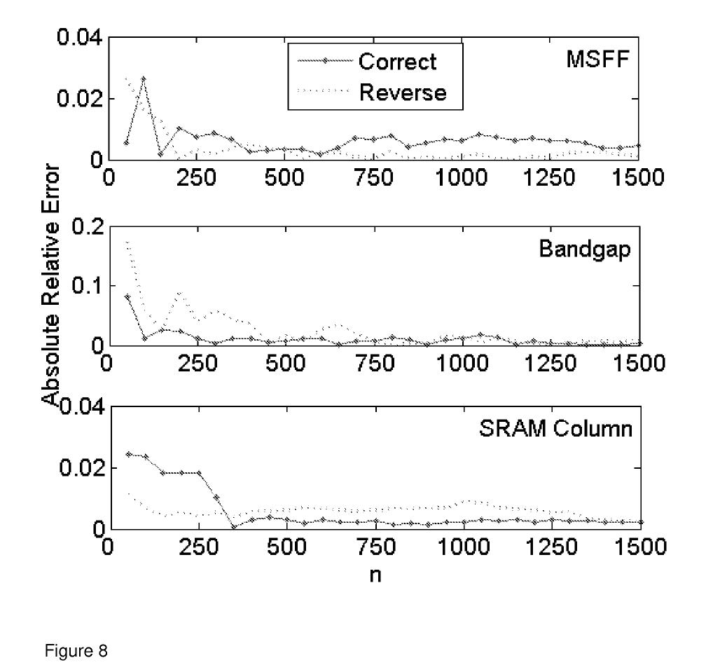

FIG. 8 plots the absolute values of the relative QMC estimate errors with two different variable orderings: 1) Correct—use the rank correlation method outlined in Section 5, and 2) Reverse—use the reverse ordering, with increasing rank correlation as the dimension increases. For the MSFF, there is not much difference in performance, since the dimensionality is low enough for all dimensions of the LDS to be similarly uniform. For the 122-D bandgap problem, the reversed mapping is slower to converge. For the 403-D SRAM column, the reverse mapping has a larger error after about 700 points. The lower error in the beginning is probably because of good point placement due to chance.

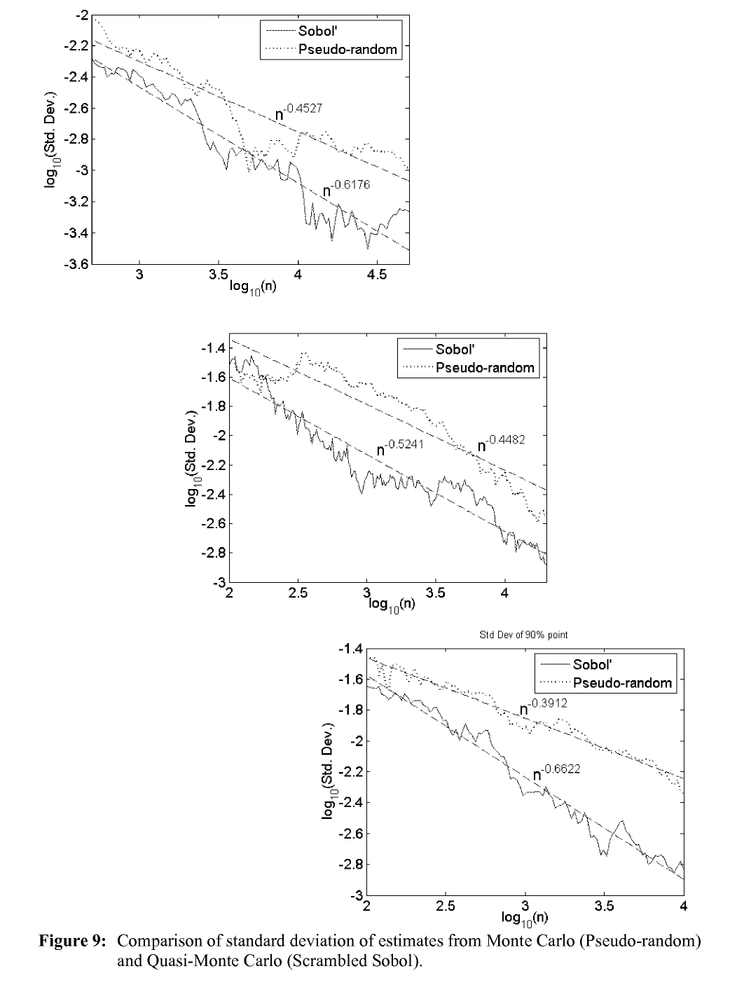

FIG. 9 compares the standard deviation (σ) of the Monte Carlo runs and the QMC runs with increasing number of points, showing the effectiveness of QMC as a variance-reduction method. The plots are in log-log scale; hence, a σ∞n^{-α} relationship will appear as a straight line with slope −α, where n is the number of samples. The plots also show straight lines, fit via least squares, to the standard deviation data, along with the relationship they represent. It can be immediately seen that QMC exhibits lower variance and faster convergence (larger magnitude) compared to Monte Carlo in all three cases. Ideally, the value of cc should be 0.5 for Monte Carlo (Equation 4). In reality, it is a little slower. Even if the convergence rate were to reach this theoretical limit for large n, QMC methods still exhibit faster convergence for the testcases studied. Furthermore, with increasing n, for QMC should tend towards 1.0, further improving the rate of convergence.

Using these fits, the number of Monte Carlo or QMC samples needed such that the result lies within a given interval for a given confidence level can be estimated. Using the Central Limit Theorem (see Background reference [30]), for a confidence level of 95.45%, this interval is [μ−2σ, μ+2σ]. Hence, for the estimates to lie within 1% deviation from the exact value, with a confidence of 95.45%, the value of a should be no greater than 0.5% of the exact value. Table 1 compares the number of points needed for Monte Carlo and QMC, for maximum errors of 1% and 0.1%, at the same confidence level. The exact value is approximated by the best estimate, shown in FIG. 7.

TABLE 1
Number of Points Needed to Achieve a Given Confidence Level for Given
Percentage Error Values

| 95.45% | MSFF | | SRAM Col. | | Banba Bandgap | |
|---|---|---|---|---|---|---|
| conf. int. | MC/QMC | Speedup | MC/QMC | speedup | MC/QMC | speedup |
| ±1% | 1114/588 | 1.9x | 1631/354 | 4.6x | 89115/10360 | 8.6x |
| ±0.1% | 180232/24465 | 7.4x | 586771/11451 | 51.2x | 15182252/838062 | 18.1x |

Moderate-to-large speedups (2× to 50×) were observed, showing the effectiveness of QMC as a variance reduction method. These speedups improve as the required accuracy increases. Here, it was assumed that the value of computed using 10 runs is exact. This is not true in reality, but, since the same assumption is being used for the Monte Carlo and QMC cases, the relative trends seen here can be believed. It should also be possible to apply other Monte Carlo variance reduction techniques (see Background reference [2]), independently, on top of QMC, to further improve accuracy.

### Conclusions

Computational finance problems share a number of the features with statistical circuit analysis problems. It has been demonstrated that one of the most celebrated techniques in the finance world, Quasi-Monte Carlo analysis, can be successfully applied to statistical circuit yield problems, with attractive runtime speedups. However, one must be quite careful in mapping these problems onto a QMC form, using appropriate sensitivity information. To the best of the inventor's knowledge, this is the largest and most rigorous experimental comparison of Monte Carlo versus QMC ideas ever undertaken in the context of industrially relevant scaled CMOS technologies and circuits.

### Second Embodiment

### Method of Applying Low-Discrepancy Sequence to Circuit Design

This embodiment involves a method used with respect to a manufacturing process for a circuit, with the manufacturing process being susceptible to simulation of quality, and the manufacturing process having a number of statistical parameters defined as “d”. The method is comprised of the steps of generating a point from a low-discrepancy sequence in a d-dimensional cube of side length one, the point having coordinates within the cube; transforming the coordinates of the point, such that the distribution changes from a uniform unit cube to that specified for the statistical parameters; creating an instance of the circuit or system, in a form suitable for detailed numerical simulation, with the values of the statistical parameters as given by the generated point; simulating the circuit using a circuit simulator, yielding measured circuit performances; combining the measured circuit performances to arrive at a current estimate of the quality; repeating the generating, transforming, creating, simulating, and combining steps until the estimate of the quality has been obtained to a desired quality; and communicating the estimate to a human user. This method would normally performed by way of programmed computing device that yields an output to a human-readable display or printout.

This method can be further extended wherein the circuit simulator is Spectre.

This method can be further extended wherein the circuit simulator is HSPICE.

This method can be further extended wherein the low-discrepancy sequence is a sequence of Sobol' points.

This method can be further extended wherein the simulation of quality comprises a simulation of reliability.

Those skilled in the art will have no difficulty devising myriad obvious variations and improvements to the invention, all of which are intended to be encompassed within the scope of the claims which follow.

What is claimed is:

1. A method for use with respect to a manufacturing process for a circuit, the manufacturing process susceptible to simulation of quality, the manufacturing process having a number of statistical parameters defined as “d”, the method comprising the steps of:
generating a point from a low-discrepancy sequence in a d-dimensional cube of side length one, the point having coordinates within the cube;
transforming the coordinates of the point, such that the distribution changes from a uniform unit cube to that specified for the statistical parameters;
creating an instance of the circuit or system, in a form suitable for detailed numerical simulation, with the values of the statistical parameters as given by the generated point;
simulating the circuit using a circuit simulator, yielding measured circuit performances;
combining the measured circuit performances to arrive at a current estimate of the quality;
repeating the generating, transforming, creating, simulating, and combining steps until the estimate of the quality has been obtained to a desired quality; and
communicating the estimate to a human user.

2. The method of claim 1, wherein the circuit simulator is Spectre.

3. The method of claim 1, wherein the circuit simulator is HSPICE.

4. The method of claim 1, wherein the low-discrepancy sequence is a sequence of Sobol points.

5. The method of claim 1, wherein the simulation of quality comprises a simulation of reliability.
